(19) United States
(12) Patent Application Publication
(10) Pub. No.: US 2009/0005810 A1
(43) Pub. Date: Jan. 1, 2009

(54) Teething device

(76) Inventor: Tracy Bonazza, Rochester, NY (US)

Correspondence Address: LAW OFFICE OF TRACY P. JONG, 2775 BUFFALO ROAD, SUITE 3, ROCHESTER, NY, 14624, US

(21) Appl. No.: 11/823,551

(22) Filed: Jun. 28, 2007

(51) Int. Cl. A61J 17/02

(52) U.S. Cl. 606/235; 606/236

(57) ABSTRACT

A teething device designed with a handle for older infants and toddlers to direct the teething surface toward their back teeth for relief from teething pain. The teething devices comprises a handle and a teething assembly fixed to the handle. The teething assembly comprises a teething surface and a mouth guard fixed to and extending outward from the teething surface.

### FIELD OF THE INVENTION

This invention relates to teething devices and more particularly, to a novel teething device designed with a handle for older infants and toddlers to direct the teething surface toward their back teeth for relief from teething pain.

### BACKGROUND

Various teething devices are known in the art to provide children relief from teething pain. When a tooth develops and protrudes from the gums, infants and toddlers suffer from gum pain, and often pain around the ears. These prior art devices typically provide a hard surface for a child to bite on, creating pressure on the sure gums where the tooth is erupting and consequently, temporary pain relief from the teething pain.

While these infant teething devices have gained popularity, they have not been successful in addressing the needs of an older infant or a toddler whose back teeth are developing. In order to facilitate the ease of handling by an infant without fine motor skills and to protect against choking hazards, these teething devices generally have a large teething surface designed not to enter into the mouth beyond the front teeth. Thus, as the back teeth begin to protrude, this device can offer no relief to the child suffering pain in the back of the mouth.

Prior art attempts to propose a solution include analgesic (e.g., ibuprofen or acetaminophen) or anesthetic medicaments (e.g., teething solutions containing lignocaine, benzyl alcohol, and myrrh tincture), and the age old rubbing the sore gums with a finger or cool spoon. Therefore, there has developed a need for a nonmedicated treatment method for teething pain in the back teeth of older infants and toddlers.

It is desirable to design a teething device with a handle for older infants and toddlers to direct the teething surface toward their back teeth for relief from teething pain that is close to the prior art teething devices, improving upon its functionality and eliminating one or more of its limitations.

### SUMMARY OF THE INVENTION

In accordance with this invention, there is provided a teething device comprising: a handle and a teething assembly fixed to the handle, wherein the teething assembly comprises a teething surface and a mouth guard fixed to and extending outward from the teething surface.

It is an object of this invention to provide a teething device with a handle for older infants and toddlers to direct the teething surface toward their back teeth for relief from teething pain.

It is a further object of the present invention to provide a teething device with a handle that selectively fixes the teething assembly to the handle, allowing for interchangeable teething assemblies and easy replacement of worn parts.

It is a further object of the present invention to provide a teething device that is versatile and readily adaptable to different mounting methods, without change in manufacturing technology for this type of teething device, or manufacturing tools; and which is simple to make and of light weight, so that it can be easily manufactured and used by older infants and toddlers.

It is yet another object of this invention to provide a relatively simple teething device that is economical for mass production from the viewpoint of the manufacturer and consumer, thereby making it economically available to the buying public.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of the claims appended to this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

### BRIEF DESCRIPTION OF THE DRAWINGS

The invention will be described by reference to the specification and the drawings, in which like numerals refer to like elements, and wherein:

FIG. 1 is a perspective view of a novel teething device;

FIG. 2 is a plan view of a child's mouth with primary teeth;

FIG. 3 is a perspective view of a child using the teething device depicted in FIG. 1;

FIG. 4A is an orthogonal side view of an alternate embodiment of a teething device;

FIG. 4B is a plan top view of a teething device depicted in FIG. 4A;

FIG. 4C is a plan bottom view of a teething device depicted in FIG. 4A;

FIG. 4D is a perspective view of another embodiment of a teething device;

FIG. 5A is an orthogonal side view of an alternate embodiment of a teething device;

FIG. 5B is an orthogonal side view of an alternate embodiment of a teething device;

FIG. 5C is an orthogonal side view of an alternate embodiment of a teething device;

FIG. 5D is a plan top view of a teething device depicted in FIG. 5C;

FIG. 6A is an orthogonal side view of one embodiment of a teething surface;

FIG. 6B is an orthogonal side view of an alternate embodiment of a teething surface;

FIG. 7 is a perspective rear view of a novel teething device with a twist lock handle;

FIG. 8 is an enlarged view of section A of FIG. 7;

FIG. 9 is a cross section along line A-A of FIG. 4B;

FIG. 10 is a perspective view of one embodiment of a teething device; and

FIG. 11 is a perspective view of one embodiment of a teething device.

The drawings are not to scale, in fact, some aspects have been emphasized for a better illustration and understanding of the written description.

### DETAILED DESCRIPTION OF A PREFERRED EMBODIMENT OF THE INVENTION

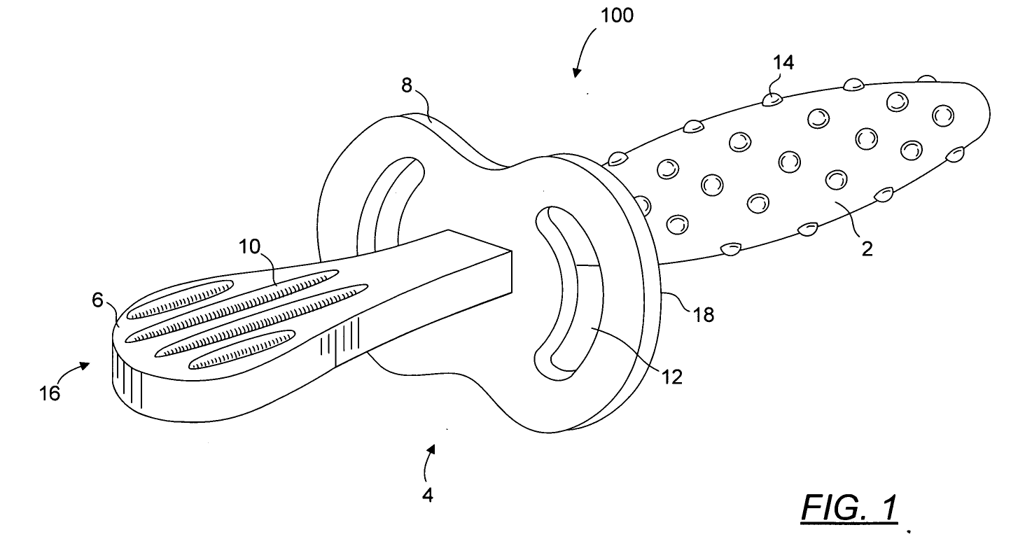

FIG. 1 is a perspective view of a novel teething device 100 comprising a handle 2 and a teething assembly 4 fixed to the handle 2, wherein the teething assembly 4 comprises a teething surface 6 and a mouth guard 8 fixed to and extending outward from the teething surface 6. Teething assembly 4 has an oral end 16 that is adapted to be inserted into an oral cavity of a child and a connecting end 18 that is adapted to be fixed to a handle 2. The mouth guard 8 is firmly attached to the teething surface 6 and prevents ingestion of the teething surface 6 by the child.

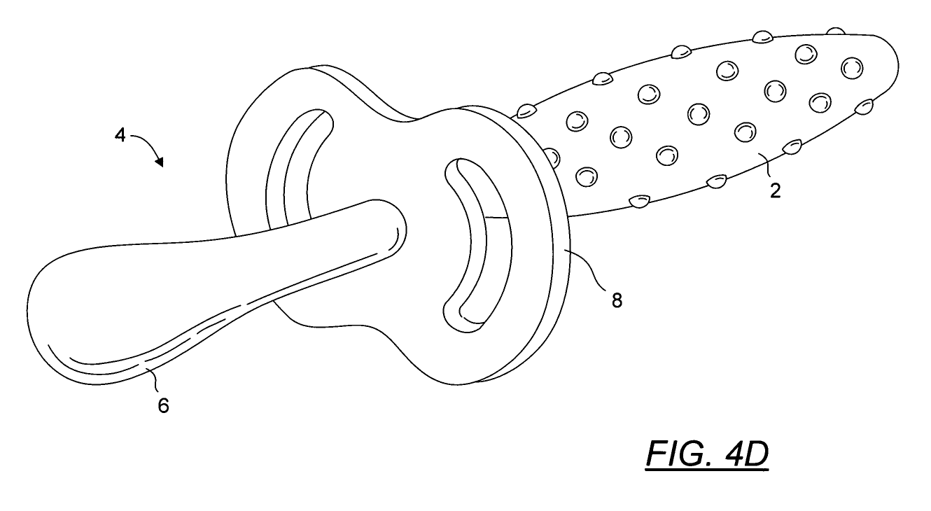

Optionally and additionally, one aspect of this embodiment may further comprise one or more additional features depicted in FIG. 1. Handle 2 is preferably textured, having a plurality of slightly raised regions, to facilitate the gripping of handle 2 by a young child, however, a handle of smooth construction may alternatively be used. By way of illustration, handle 2 may contain a textured surface such as bumps or protrusions 14. It is to be understood that various textured surfaces on handle 2 may be used with this invention, including ridges, channels, hatching, woven patterns, stripes, spirals, zig zags, concave portions, indents, and the like. (By way of example, reference is made to handles 72, 76 and 80 described below in the drawings and description of FIGS. 5A, 5B and 5C.) Patterns in the textured surface may be random, intermittent or repeating. Patterns may be dense or sparse. In a preferred embodiment, stimulating bright colors are used. Handles shaped like animals, people or other characters are also included within the scope of the present invention. Handle 2 may be formed in any variety of manners, sizes, colors and materials used with infant and toddler silverware and/or toothbrushes.

As depicted in the aspect of the embodiment in FIG. 1, teething surface 6 contains a textured surface such as ridges 10. It is to be understood that various textured surfaces may be used with the teething surface this invention, including ridges, channels, hatching, woven patterns, stripes, spirals, zig zags, concave portions, indents, and the like. Patterns may be random, intermittent or repeating. Patterns may be dense or sparce. (By way of example, reference is made to teething surface 70, 74 and 78 described below in the description of FIGS. 5A, 5B and 5C.) In a preferred embodiment, stimulating bright colors are used. Teething surface 6 may be formed in any variety of manners, colors and materials used with infant and toddler pacifiers and teething devices.

As depicted in the aspect of the embodiment in FIG. 1, a mouth guard 8 is fixed to and extending outward from the teething surface 6. The mouth guard 8 must be of sufficient size and structurally inflexible that it can not be sucked into a child's mouth. The mouth guard 8 is usually made from relatively hard plastic and is contoured to comfortably fit against the area adjacent a child's mouth. In one preferred embodiment, mouth guard 8 contains breathing apertures 12 located and configured to permit the free flow of air to and from a child's nose when teething device 100 is in use in a child's mouth. It is to be understood that various aperture shapes may be used with this invention, including holes (as depicted in FIG. 5D), slits, kidney bean shaped apertures (as depicted in FIG. 1), and the like. Breathing apertures 12 also operate to ensure that in the event of a child ingesting the mouth guard 8, the breathing apertures 12 permit air to pass through to the windpipe. In a preferred embodiment, breathing apertures and mouth guard 8 are configured and sized to satisfy all pertinent regulations and laws.

As depicted in the aspect of the embodiment in FIG. 1, mouth guard 8 has a non-circular cross-section. In one aspect, the cross section has a butterfly-like shape. It is to be understood that various mouth guard shapes may be used with this invention, including round (as depicted in FIG. 5D), kidney bean shaped, and the like. It is necessary that the mouth guard be configured and dimensioned to prevent entry of the teething assembly 4 into a child's mouth. Mouth guards are known in the art and commonly used with infant pacifiers. Any design and size of pacifier mouth guard may be suitably adapted to the mouth guard 8 of the present invention.

A child's first tooth most often breaks through the gum after about 5 months of age, but this can vary quite a bit. In fact, some children already have a tooth when they are born (it may be a real tooth or an extra tooth).

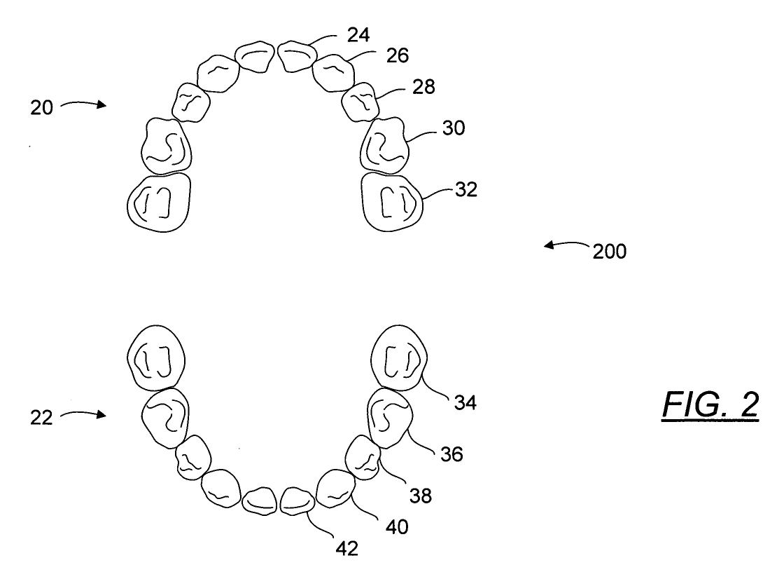

FIG. 2 depicts a plan view of a child's mouth 200 with primary teeth. The upper jaw primary teeth 20 and lower jaw primary teeth 22 are shown. The primary teeth, also commonly referred to as “first teeth” or “baby teeth,” generally erupt through the gums between 7 and 33 months of age as follows:

### Upper Teeth

| | |
|---|---|
| Central incisors 24 | 7-12 months of age |
| Lateral incisors 26 | 9-13 months of age |
| Canines (cuspids) 28 | 16-22 months of age |
| First molars 30 | 13-19 months of age |
| Second molars 32 | 25-33 months of age |

### Lower Teeth

| | |
|---|---|
| Central incisors 42 | 6-10 months of age |
| Lateral incisors 40 | 7-16 months of age |
| Canines (cuspids) 38 | 16-23 months of age |
| First molars 36 | 12-18 months of age |
| Second molars 34 | 20-31 months of age |

During teething, a child's gum may be swollen in the spot where a tooth is about to break through or erupt. Tooth eruption is the process by which a tooth moves from its site of development within the jaws to its final functional position in the oral cavity. The tooth itself seems to play no active role in the process. The dental follicle, which is a rich source of eicosanoids, cytokines, and growth factors, plays an important role, thus explaining local symptoms that are inflammatory or irritative in nature.

Older infants and toddlers can be difficult to treat therapeutically. It is preferable that a successful treatment regimen appeal to instinctive inclinations and behaviors for this age group. Teething infants show significantly more mouthing, sucking, and drooling than nonteething infants. It is also known that drooling and chewing on objects (or rubbing them against the gum) are a natural part of an infant's development and may or may not signify teething. Thus, teething devices which work by chewing and rubbing on the gums (thus applying pressure on the gums at the site of teething pain) will be easily adaptable to older infants and children. As used in this specification, infant shall mean a child from birth to 24 months of age. As used in this specification, toddler shall mean a child from 25 to 48 months of age. As used in this specification, child shall mean infants and toddlers (birth to 48 months of age).

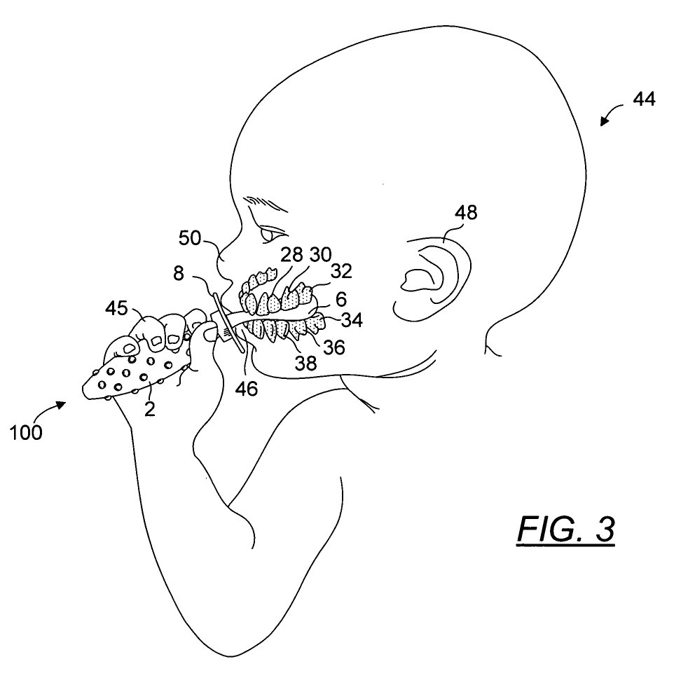

FIG. 3 depicts a perspective view of a child 44 using teething device 100. To use the teething device 100, a child holds the handle 2 with his hand 45, inserts the teething surface 6 into his mouth 46. Fluids do no pass through the teething surface 6, rather, the action of pressing or biting on the teething surface 6 is thought to soothe or calm the sore gums, quieting the child, and alleviating the burning and itching of the gums during teething. The mouth guard 8 rests on the child's lips and will impose a physical barrier limiting the depth of insertion of the teething surface 6 into the mouth 46. Preferably, mouth guard 8 should not impose a restriction on the flow of air to and from the child's nose 50.

As depicted in FIG. 3 when teething device 100 is in use, the teething surface 6 is in contacting engagement with first molars 30, 36 and/or second molars 32, 34. In some aspects, the teething surface 6 is alternatively or additionally in contacting engagement with canines 28, 38.

Whereas teething device 100 is to apply pressure on the gums at the site of teething pain, it may be in contacting engagement with the gums in the area of any of the primary teeth 24, 26, 28, 30, 32, 34, 36, 38, 40, 42 (of FIG. 2). The best application of the present invention is when teething device 100 is used to apply pressure on the gums at the site of teething pain in the rear of the mouth, e.g., gums in the area of first molars 30, 36 and/or second molars 32, 34 and/or canines 28, 38. Mouth guard 8 does not block airflow to or from the child's nose 50. The biting action on the teething surface 6 also relieves pain in the child's ear 48.

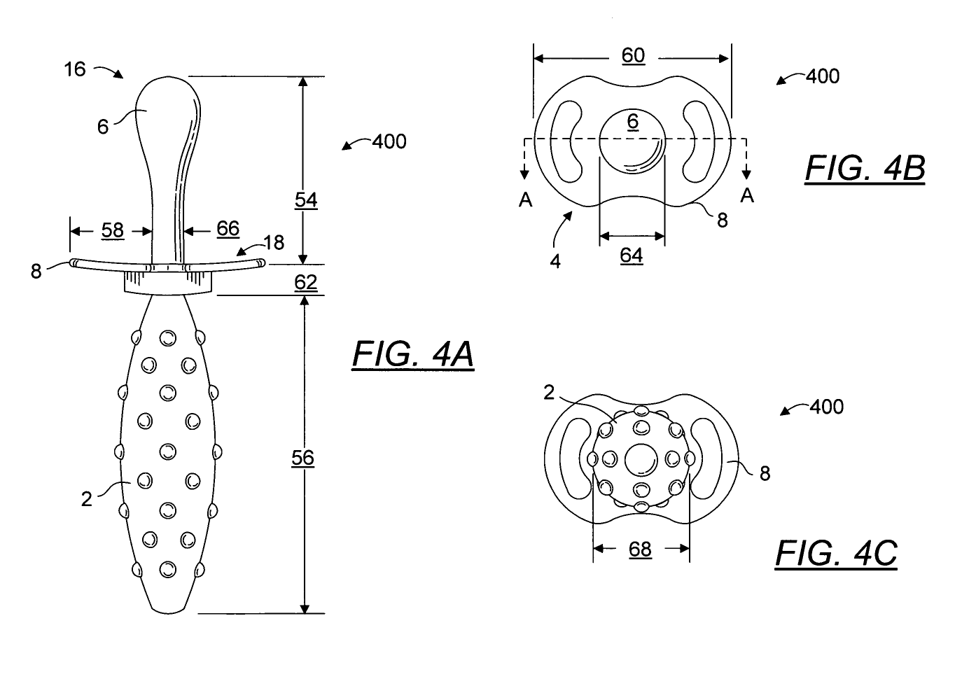

FIG. 4A is an orthogonal side view of an alternate embodiment of a teething device 400. Referring to FIG. 4A, teething surface 6 has a length 54 of from about one to about two inches, preferably about one and three-fourths inches. Handle 2 has a length 56 of from about two to about three inches, preferably about two and three-fourths inches. Mouth guard 8 extends a distance 58 of from about 0.5 to about 1.5 inches outward from the teething surface, preferably 0.75 inches, and has a width of from about 1.5 to about 2.25 inches, and has a diameter 60 (see FIG. 4B) of from about two to about three inches, preferably about two and one-half inches. Mouth guard 8 extends a distance 62 (see FIG. 4A) of from about ⅛ inch to about 1 inch between teething surface 6 and handle 2.

Referring again to FIGS. 4A and 4B, teething surface 6 has a width or diameter 64 of from about 0.25 to about 0.75 inches, preferably about 0.5 inches, at its widest point and a width or diameter 66 of from about 0.25 to about 0.75 inches, preferably about 0.25 inches, at its narrowest point. In one aspect of this embodiment, the circumference of the teething surface 6 at the oral end 16 of the teething assembly 4 is from about 5 to about 300, preferably from about 100 to about 200, percent greater than the circumference of the teething surface 6 at the connecting end 18 of the teething assembly 4.

FIG. 4B is plan top view of a teething device depicted in FIG. 4B for clarification and additional views thereof.

FIG. 4C is plan bottom view of a teething device depicted in FIG. 4A for clarification and additional views. Referring to FIG. 4C, handle 2 has a width or diameter 68 of from about 0.5 to about 1.5 inches, preferably about 0.75 inches, at its widest point and 0.5 to about 0.75 inches at its narrowest point. In a preferred embodiment, handle 2 is dimensioned according to the handles of toddler silverware and toothbrushes.

FIG. 4D is a perspective view of another embodiment of a teething device. This embodiment is substantially the same as depicted and described with respect to embodiment 100 with the exception that the embodiment in FIG. 4D has a bulb shaped teething surface 6.

FIG. 5A is an orthogonal side view of an alternate embodiment 500 of a teething device. In the embodiment depicted, handle 72 contains a textured surface comprising bumps or protrusions 14. Teething surface 70 also contains a textured surface comprising bumps or protrusions 86.

FIG. 5B is an orthogonal side view of an alternate embodiment 600 of a teething device. In the embodiment depicted, handle 76 contains a textured surface comprising ribs or ridges 88 and teething surface 74 contains a textured surface comprising ribs or ridges 90. In one embodiment, strengthening ribs impart additional strength and allow distribution of the stress to permit the teething surface 74 to retain its shape under stress and thereby improve its capability to resist deformation. While strengthening ribs and other formed structures are used for strengthening and supporting the teething surface 6 in some embodiments, it will be understood that various other shapes and supporting features/methods could be used with the teething device 100 of the present invention.

FIG. 5C is an orthogonal side view of an alternate embodiment 700 of a teething device. In the embodiment depicted, handle 80 contains a multi-textured surface comprising bumps or protrusions 14 on a first portion 94 and a smooth texture on a second portion 96. Teething surface 78 contains a non-textured surface 92.

FIG. 5D is a plan top view of a teething device 700 depicted in FIG. 5C. In the embodiment depicted, mouth guard 82 is round as well as its breathing apertures 84. Teething surface 78 comprises a rounded or bulb-like shape. This differs from the flat teething surface 6 depicted in FIG. 1.

As will be clear to those skilled in the art, many combinations of teething surfaces 6, handles 2, and mouth guards 8 may be used with and are within the scope of the present invention.

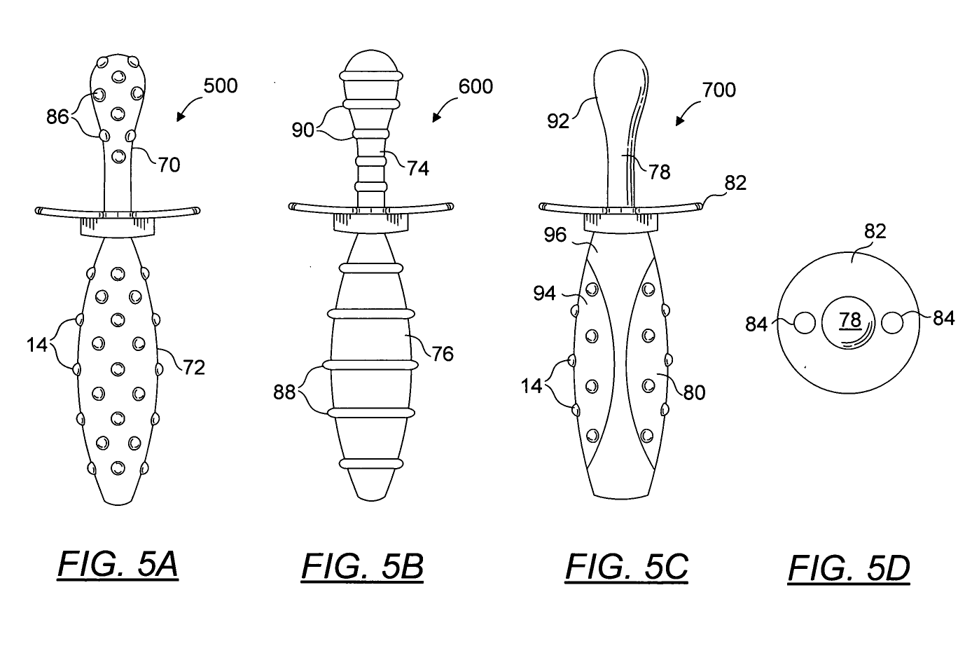

FIG. 6A is an orthogonal side view of one embodiment of a teething surface 78. In the embodiment depicted, teething surface 78 comprises a rounded or bulb-like shape having an exterior wall 104 and an interior cavity 102. In one embodiment, teething surface 78 comprises a hollow interior cavity 102 defined in part by thin, flexible walls constructed of soft rubber material or any other suitable elastomeric material as would be appreciated by those skilled in the art. In one aspect of this embodiment, the interior cavity contains a sterile nontoxic liquid. In a preferred embodiment, the sterile nontoxic liquid comprises distilled or sterile water.

FIG. 6B is an orthogonal side view of an alternate embodiment of a teething surface 78A. In the embodiment depicted, teething surface 78A comprises a solid rounded or bulb-like shape and no cavity.

Referring again to FIG. 1, in some embodiments of teething device 100, the teething assembly 4 is permanently fixed to the handle 2. In some embodiments of teething device 100, the teething assembly 4 is selectively fixed to the handle 2. Any mechanism for selectively and securely engaging two members 2, 4 may be suitably used with this invention. Such mechanisms may include, for example, snap lock fasteners, double locking snap lock assemblies, locking snap hooks, twist lock assemblies, locking collars, twist lock couplings, magnetic snap locks, and the like. See U.S. Pat. Nos. 4,796,628; 5,908,440; 6,318,683 and published United States patent application 20060142800A1.

In a preferred embodiment, a child-proof assembly is utilized to prevent choking hazards. Child-proof assemblies are well known in the art, but essentially require fine motor skills to perform two simultaneous actions such as pressing and twisting, pressing and pulling, and the like. In one aspect of the embodiment with a selectively fixed handle, the teething device further comprises a snap lock assembly configured such that the teething assembly comprises a first portion of the snap lock assembly and the handle comprises a mating second portion of the snap lock assembly.

In another aspect of the embodiment with a selectively fixed handle, the teething device further comprises a twist lock assembly configured such that the teething assembly comprises a first portion of the twist lock assembly and the handle comprises a mating second portion of the twist lock assembly. (It is to be understood that this may be reversed such that handle comprises a first portion of the twist lock assembly and the teething assembly comprises a mating second portion of the twist lock assembly.) In preferred embodiments, the twist lock structure is a push-twist lock structure. This structure has a resilient spring type element located in the twist lock handle 110 to hold the protrusions in a groove or recess of the cooperative portion of the twist lock. The resilient elements useful in accordance with this invention are capable of exerting a biasing force between two elements. They are resilient elements capable of storing energy when compressed and recover their basic form when the compressive forces are released. In order to disconnect the push-twist lock coupling, a pushing force against the resilient spring type element is required in addition to a turning force. The term push-twist lock as used herein refers to a twist lock that requires a pushing force as well as a turning force to disconnect the coupling.

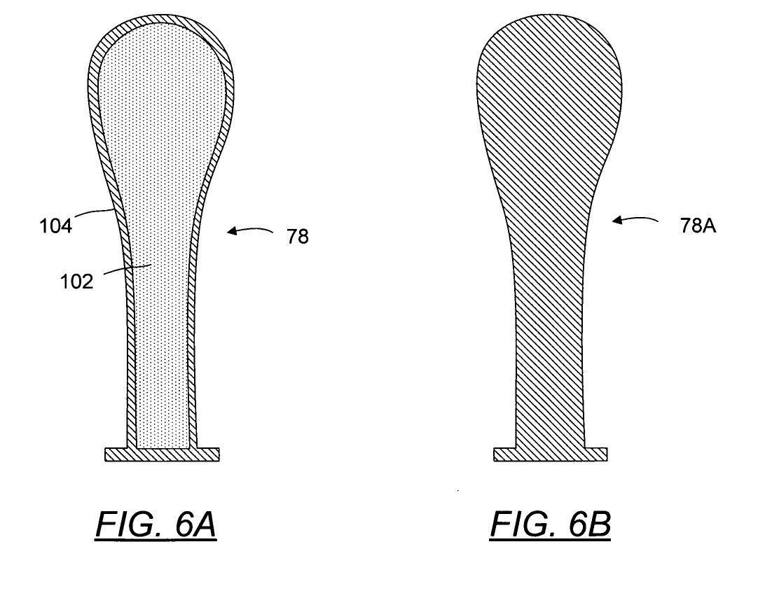

FIG. 7 is a perspective rear view of a teething device 700 with a twist lock handle 110 that selectively engages teething assembly 112 with twist lock handle 110. Twist lock bottle caps and fasteners are well known in the art for making child resistant bottle caps for pharmaceuticals, hazardous materials, and the like. See for example, U.S. Pat. Nos. 4,345,691; 3,989,152; 4,893,978; 4,832,218; and 5,725,114 and the patents referenced in and by these patents. The respective cooperative component parts of the twist lock couplings and the push-twist lock couplings can be located in the teething assembly 112 and twist lock handle 110 in any manner and configured such that the necessary alignment and positioning of the lock components is maintained to achieve a firm lock. In the embodiment depicted, a ratcheting mechanism is incorporated.

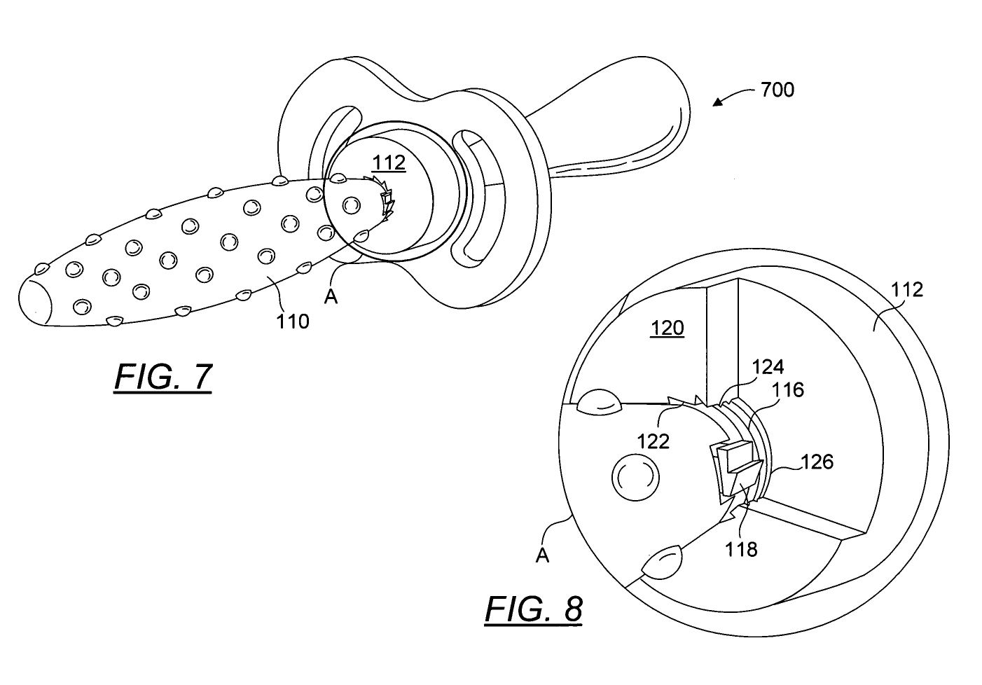

FIG. 8 is an enlarged view of section A of FIG. 7. In the embodiment depicted, twist lock handle 110 selectively engages teething assembly 112 via corresponding first attachment region 126 of twist lock handle 110 and second attachment region 120 of teething assembly 112. The first attachment region 126 includes a first threaded portion 116, and the second attachment region 120 includes a second threaded portion 124. The twist lock handle 110 is secured to teething assembly 112 through threaded engagement of the first threaded portion 116 and the second threaded portion 124.

In one embodiment, first attachment region 126 of twist lock handle 110 includes at least one ratcheting protrusion 118, and the second attachment region 120 of teething assembly 112 includes at least one ratcheting protrusion 122. The engagement of the at least one ratcheting protrusion 122 with the at least one ratcheting protrusion 118 inhibits separation of the twist lock handle 110 from the teething assembly 112 until the child-proof mechanism is released.

In a preferred embodiment, first attachment region 126 of twist lock handle 110 includes a plurality of ratcheting protrusions 118, and the second attachment region 120 of teething assembly 112 includes a plurality of ratcheting protrusions 122. In one aspect of this embodiment, at least one of the ratcheting protrusions 118, 122 is spring loaded. The retaining member is secured to the housing through operative engagement of the first and second attachment regions. Thus, disengagement of the first 126 and second 120 attachment regions is inhibited until this child-proof locking mechanism is released.

The disengagement will now be described. When sufficient opposing pressure is applied by one or two fingers compressing release points (not visible on this Figure) on the handle, the first 126 and second 120 attachment regions compress inwardly, allowing them to move slightly and disengage the ratcheting protrusions 118, 122 from one another. This allows for twisting to commence and therefore disengagement of the twist lock handle 110 from the teething assembly 112.

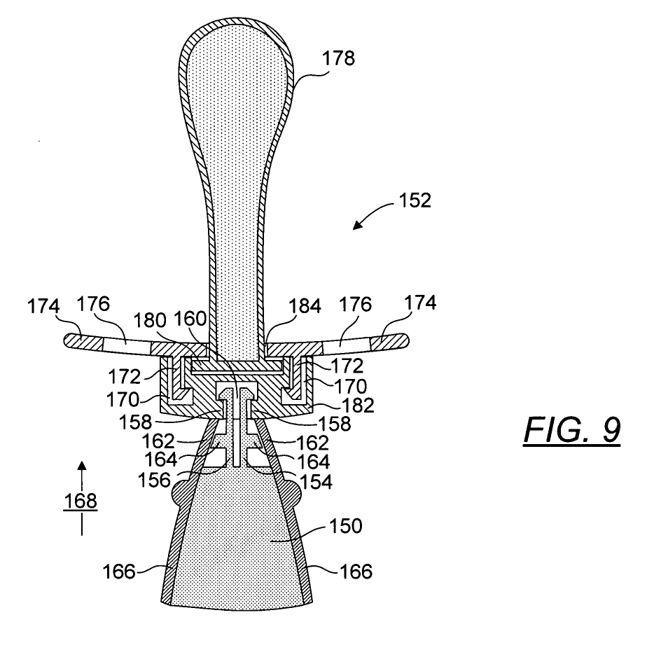

FIG. 9 is a cross section along A-A of FIG. 4B depicting a teething device with a snap lock handle 150 that removably engages with teething assembly 152. FIG. 9 illustrates one way teething assembly 152 may be assembled if it is not molded as a single unit. In the embodiment depicted, the mouth guard comprises a base 182 with a center latching aperture 160 and a plurality of mouth guard latching apertures 170 adapted to receive and securely affix latching members 172 of the lip shields 174. Lip shields 174 protrude outwardly from teething surface 178 and further comprise breathing apertures 176. Teething surface 178 includes a retaining flange 180. The lip shields 174 are configured with respect to base 182 such that they form an aperture 184 through their centers. The aperture 184 is sized to restrict and prevent retaining flange 180 from moving, thereby securing the same. The latching apertures 170 are sized to restrict and prevent lip shields 174 from moving, thereby securing the same.

While the lip shields 174 and teething surface 178 are permanently secured about the mouth guard, snap release handle 150 is removably engaged. When sufficient opposing pressure is applied to spring type elements 154, 156 by latching elements 158, spring type elements 154, 156 compress inwardly, allowing them to move slightly inwardly. Pressure is applied, for example, when snap lock handle 150 is in alignment with center latching aperture 160 and snap lock handle 150 is pressed in the direction 168 toward and into center latching aperture 160. When this opposing inward pressure is removed, spring type elements 154, 156 return to their uncompressed state.

Similarly, when sufficient opposing pressure is applied to spring type elements 154, 156 by one or two fingers compressing release point 162, spring type elements 154, 156 compress inwardly, allowing them to move slightly inwardly. As may be more clearly seen with reference to FIG. 9, when two fingers simultaneously compress release points 162, exterior walls 166 of handle 150 contact protrusions 164 of spring type elements 154, 156, thereby causing them 154, 156 to compress inwardly. As the spring type elements 154, 156 compress inwardly, their dimensions becomes smaller than the diameter of center latching aperture 160. This allows for disengagement of the snap lock handle 150 from the teething assembly 152.

Resilient spring type elements 154, 156 are preferably made of a relatively rigid plastic material, although not so rigid as to inhibit their spring-like action. The resilient spring type elements 154, 156 can be molded into the snap lock handle 150 or can be attached by adhesives, or welding techniques used for attachment of the respective materials. A resilient spring type element 154, 156 is preferably molded into the snap lock handle 150 at the time it is molded.

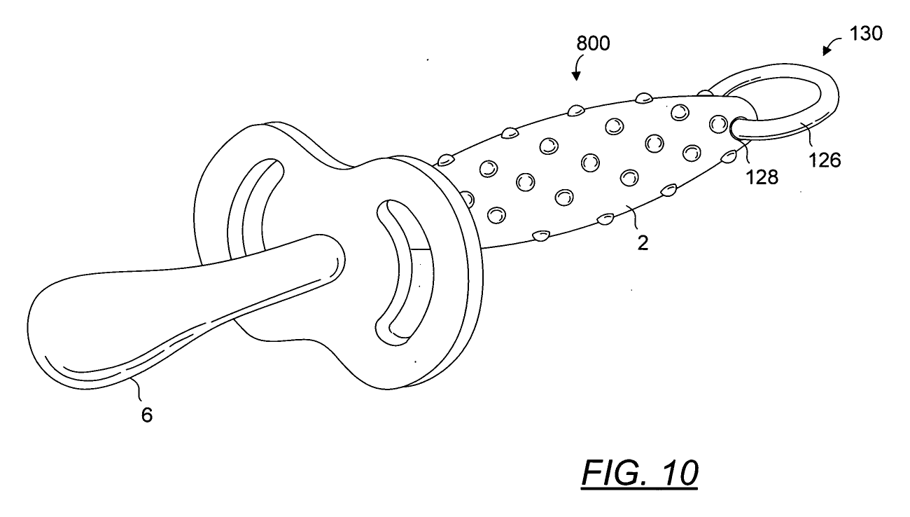

FIG. 10 is a perspective view of one embodiment 800 of a teething device. The embodiment 800 depicted is substantially the same as depicted and described with respect to embodiment 100 (see FIG. 1) with the exception that teething surface 6 is bulb shaped as depicted and described with reference to FIGS. 4A and 5C, and handle 2 further comprises an aperture 128 adapted to receive a circular loop 126 bottom 130.

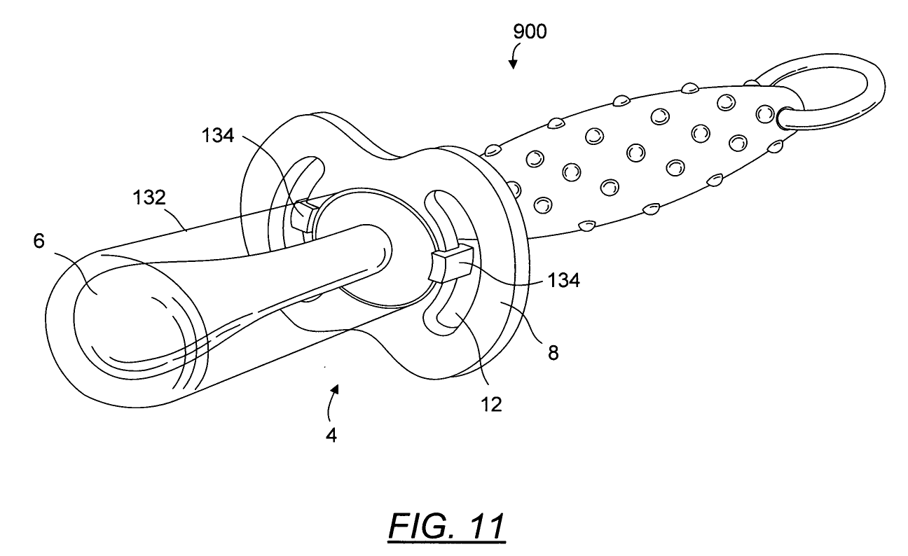

FIG. 11 is a perspective view of one embodiment 900 of a teething device. The embodiment 900 depicted is substantially the same as depicted and described with respect to embodiment 800 (see FIG. 10) with the exception that teething assembly 4 further comprises a hygienic cover 132, covering at least a portion of the teething surface 6. The means for releasably attaching the teething assembly 4 and the hygienic cover 132 may be carried out in a number of ways. In the preferred embodiment, the hygienic cover 132 is provided with snap lock parts 134 extending outwardly from the external sides thereof and apertures 12 are formed on the mouth guard 8 adapted for receiving the snap lock parts 134 on the hygienic cover 132. Although the preferred embodiment of the present invention utilizes the snap locking means to hold the two pieces together, it should be noted that the connecting means of the present invention can take any other suitable form capable of releasably securing the hygienic cover 132 to the teething assembly 4 during when teething device 900 is not in use. As depicted in FIG. 11, securing clips 134 selectively and removably affix the hygienic cover 132 to the mouth guard 8. In a preferred embodiment, hygienic cover 132 is of sufficient size that is does not present a choking hazard to a child, that is, of sufficient size and structurally inflexible that it can not be sucked into a child's mouth. As will be appreciated, many configurations and shapes of hygienic cover 132 may be suitably used with the present invention.

### Manufacturing Methods and Materials

In a preferred embodiment, the teething surface 6 (see FIG. 1) and mouth guard 8 are formed of one material and molded together (see teething assembly 4 of FIG. 1) so that the two do not have to be fused during the manufacturing process. Such a manufacturing process reduces the risk for failing at that juncture and creating a potential choking hazard.

In a preferred embodiment, the teething assembly 4 is manufactured so as to comply with any applicable regulations concerning pacifiers, infant and child devices, and the like, including but not limited to the United States Consumer Product Safety Commission's Requirements for Pacifiers to the extent such may be applicable to the present invention in any particular embodiment.

The teething surface 6 is made from latex, silicone or plastic. In aspects of this embodiment formed of plastic, it is preferred that a hard plastic be used. While softer plastics may be used, hard plastics are preferable since softening plastics requires chemical additives that have proven to be harmful to small children and resulted in federal government recalls because harmful additives were used in the processing of the raw materials.

In one embodiment, the teething device 100 comprises a material that is nontoxic, strong, waterproof, and durable for the typical conditions encountered by a teething aid. In one embodiment, it is preferred that the material be easily washable. By way of example, but not limitation, in one embodiment, the teething device 100 is constructed of a thermoformable plastic such as polypropylene or polyethylene. In a preferred embodiment, the present invention is molded of a cross linked polyethylene.

Latex, also known as natural rubber latex, produced by the rubber tree Hevea brasiliensis is used in the manufacture of teething surface 6 is some embodiments. By processes and technologies well known in the art, chemicals are added to raw latex to increase elasticity and strength. Whereas proteins found in this natural material have caused severe allergic reactions in some consumers, it is preferred that the latex be treated to counteract the effect of these proteins on consumers.

Whereas latex does not survive repeated “boil and cool tests” in which the product is boiled, cooled, and then assessed for its ability to retain shape and perform successfully, it has been recognized that latex disintegrates more quickly than other substances. This is of concern as oral devices for children cannot be repeatedly boiled or washed for sterilization without risk of disintegration. Therefore, latex is a lesser preferred material for construction of the teething device 100.

In a preferred embodiment, the teething surface 6 (see FIG. 1) and mouth guard 8 are formed of silicone. Silicone is more expensive than latex but of superior performance. Silicones are synthetic polymers that are relatively chemically inert, stable at high temperatures, and resist oxidation. Thus, silicone is able to survive the boil and cool cycle far better than latex and therefore superior for products requiring sterilization. In a preferred embodiment, the teething surface 6 (see FIG. 1) and mouth guard 8 are formed of silicone that is “certified,” meaning it is of a superior grade for oral use.

In a preferred embodiment, teething assembly 4, handle 2 or teething device 100 is made of one-piece construction with the production occurring in one stage using liquid injection molding. Liquid injection molding of molten polymers (“melt”) with a high viscosity require the application of a large force to inject the polymer into a hollow mold.

These injection molding manufacturing processes are well known in the art. Any known process may be used with this invention. In one embodiment, pellets of polymer are melted at very high temperatures, usually 360-420° F. (182-216° C.) and then fed from a hopper into a machine that liquefies the pellets. Thereafter, the melt is rammed into the mold at very high speed and under intense pressure, approximately 300-700 psi. The melt fills the mold, and then a bit more melt is added in order to compensate for the contraction due to cooling and solidification of the polymer. Once the polymer has cooled, it is separated from the mold. This solidified part is simply ejected from the mold automatically, and the melt and injection cycle is ready to begin again. Each cycle takes between 10 and 100 seconds depending on the time it takes the polymer to cool and set. The one-piece teething assembly 4, handle 2, or teething device 100 is then inspected, sterilized and hygienically packaged for shipment.

In another embodiment, the present invention is manufactured according to any method known to, or devised by, one skilled in the art for the manufacture of teething aids and/or pacifiers.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including such equivalent construction insofar as they do not depart from the spirit and scope of the conception regarded as the present invention.

I claim:

1. A teething device, comprising:
a handle; and
a teething assembly fixed to the handle, comprising:
a teething surface; and
a mouth guard fixed to and extending outward from the teething surface.

2. The teething device of claim 1, wherein the teething assembly is permanently fixed to the handle.

3. The teething device of claim 1, wherein the teething assembly is selectively fixed to the handle.

4. The teething device of claim 3, wherein the teething device further comprises a snap lock assembly, wherein the teething assembly comprises a first portion of the snap lock assembly and the handle comprises a mating second portion of the snap lock assembly.

5. The teething device of claim 3, wherein the teething device further comprises a twist lock assembly, wherein the teething assembly comprises a first portion of the twist lock assembly and the handle comprises a mating second portion of the twist lock assembly.

6. The teething device of claim 1, wherein the teething surface is dimensioned to extend to one or more teeth of a human.

7. The teething device of claim 6, wherein the human is from about 6 months to about 48 months in age and wherein the teeth are selected from the group consisting of First Molars, Second molars, Canines, and combinations thereof.

8. The teething device of claim 7, wherein the mouth guard is dimensioned to prevent entry of the teething assembly into a mouth.

9. The teething device of claim 1, wherein the teething surface comprises a textured surface.

10. A teething device, comprising:
a handle; and
a teething assembly fixed to the handle, comprising:
a teething surface having a length of from about one to about two inches; and
a mouth guard fixed to and extending outward from the teething surface.

11. The teething device of claim 10, wherein the handle has a length of from about two to about three inches.

12. The teething device of claim 10, wherein the mouth guard extends a distance of from about 0.5 to about 1.5 inches outward from the teething surface.

13. The teething device of claim 10, wherein the teething surface comprises a material selected from the group consisting of latex, plastic, and silicone.

14. The teething device of claim 10, wherein the handle comprises a textured surface.

15. The teething device of claim 10, wherein the teething surface further comprises an interior cavity.

16. The teething device of claim 15, wherein the interior cavity contains a sterile nontoxic liquid.

17. The teething device of claim 16, wherein the sterile nontoxic liquid comprises water.

18. A teething device, comprising:
a handle having a textured surface; and
a teething assembly fixed to the handle, comprising:
a teething surface having a textured surface; and
a mouth guard fixed to and extending outward a distance of from from the teething surface, wherein the mouth guard is dimensioned to prevent entry of the teething assembly into a mouth.

19. The teething device of claim 18, wherein the teething assembly is selectively fixed to the handle.

20. The teething device of claim 19, wherein the teething surface comprises a material selected from the group consisting of latex, plastic, and silicone.
